(19) United States
(12) Patent Application Publication
(10) Pub. No.: US 2012/0284139 A1
(43) Pub. Date: Nov. 8, 2012

(54) METHOD AND APPARATUS FOR PROVIDING A HOMOGENEOUS DISCRIMINATORY PRICE AUCTION WITH SECRET RESERVE

(75) Inventor: FRANCIS A. POWELL, Chicago, IL (US)

(73) Assignee: PAZARI LLC, Chicago, IL (US)

(21) Appl. No.: 13/297,079

(22) Filed: Nov. 15, 2011

Related U.S. Application Data
(60) Provisional application No. 61/481,839, filed on May 3, 2011.

(51) Int. Cl. G06Q 30/08

(52) U.S. Cl. 705/26.3

(57) ABSTRACT

Method, apparatus, and computer-readable medium are provided for facilitating an auction of at least one item. In one example, the method includes obtaining one or more bids for the at least one item being auctioned, determining which of the one or more bids meet a secret reserve price associated with the at least one item, selecting at least one winning bid from among the one or more bids meeting the secret reserve price, and maintaining the secret reserve price and the at least one winning bid in confidence following expiration of the auction. Related apparatus and computer-readable medium are also provided.

### FIELD

The present disclosure relates to a method and apparatus for providing an auction.

### BACKGROUND

On-line auction websites have become extremely popular in recent years due to their ability to provide goods and services at prices that are generally well-below retail prices. One well-known on-line auction website is eBay.com. eBay® and similar sites utilize a traditional single-unit auction model, whereby the auction host (i.e., auctioneer) places a single item (e.g., a good or service) up for auction and accepts bids from one or more bidders for a predetermined amount of time. At the expiration of the auction, the bidder with the highest bid “wins” the auction and is rewarded with the good/service that was placed up for auction.

During the life of the auction (i.e., when the auction is open and bids are being accepted), the price of the highest bid is published on the website so that subsequent bidders know exactly how much they must bid in order to win the auction. Consequently, auction models, such as the model utilized by eBay, encourage “price sniping”—the firing off of rapid, penny-increment bids in the waning moments of the auction in order to win the auction without substantially outbidding the nearest losing bid. In fact, price sniping has become so prevalent that tools have arisen that are capable of automatically incrementing a user's bid over the current winning price, without requiring the user themselves to input the new highest bid. For example one such automated bidding system is disclosed in U.S. Pat. No. 7,315,832 entitled “ON-LINE BIDDING SYSTEM,” issued to Bauer et. al.

More recently, “daily deal” websites have emerged as a popular vehicle for selling goods or services. One well-known daily deal site is Groupon.com. Groupon® and similar sites establish a reduced “deal price” with a supplier for a given good or service and attempt to sell as many of the discounted goods/services as possible in the limited amount of time that the deal is valid.

However, existing auction websites and daily deal websites suffer from a number of drawbacks. For example, with respect to eBay and similarly modeled on-line auction websites, typically only a single unit (e.g., a single t-shirt or concert ticket) may be auctioned at a time. If an auctioneer using eBay or a similar site wants to unload a plurality of identical items, they must set-up “clone” auctions and manage them all individually. This can be a cumbersome and inefficient undertaking. Furthermore, and as noted above, on-line auction websites such as eBay are susceptible to price sniping.

On-line auction websites that are susceptible to price sniping are known to deter customers—especially customers who are not fortunate enough to have automated bidding software executing their bids for them. This is because customers who interact with the auction in a conventional manner (i.e., manually enter their bids) are oftentimes not fast enough to compete with automated bidding software (or other bidders who monitor the auction like a hawk, for that matter) in the waning moments of an auction's lifetime, and therefore are likely to lose out on auctions where the winning bid is only nominally higher than their last bid (e.g., one penny higher). Consumers who lose out on an auction by a few cents are naturally deterred from engaging with such an on-line auction website in the future, as such auctions may be perceived as a waste of time.

In addition, because on-line auction websites publish the winning bid price, they are known to deteriorate the price of the good or service in the external marketplace. This can have a detrimental financial impact on the manufacturers and distributors of the good or service put up for auction. For example, when consumers see that a particular product sold at auction for a price well-below retail, they may associate that product with a lower value and the overall brand of that product becomes damaged. That is, traditional on-line auction websites are known to lead to brand deterioration.

Daily deal websites such as Groupon may also lead to brand deterioration. For example, a daily deal site that offers high-end goods or services at drastically reduced prices may deteriorate, or in some cases entirely destroy, the retail market for that good or service. Furthermore, sellers/suppliers of goods or services offered through daily deal sites regularly provide the good or service at a price that is well below what many consumers would be willing to pay. However, because the seller/supplier is required to negotiate a fixed price up-front, they lose out on the opportunity to sell the good or service for a higher price to those consumers who would be willing to pay it.

Accordingly, a need exists for a method and apparatus designed to provide an on-line auction that (i) is not susceptible to price sniping, (ii) allows a seller/supplier to offer multiple items of the same good or service (i.e., “homogeneous” items) via a single auction, (iii) provides an added degree of protection against brand deterioration, and (iv) provides sellers/suppliers the opportunity to capture bids on a given good or service that are well-above the drastically reduced price traditionally associated with daily deal sites.

### SUMMARY

The instant disclosure describes techniques and apparatuses for facilitating an auction of at least one item. To this end, in one example, an apparatus is provided. In this example, the apparatus includes at least one processing device and memory operatively connected to the at least one processing device. The memory includes executable instructions capable of execution by the at least one processing device. Executing these executable instructions causes the at least one processing device to: (i) obtain one or more bids for the at least one item being auctioned; (ii) determine which of the one or more bids meet a secret reserve price associated with the at least one item; (iii) in response to determining that any of the one or more bids meet the secret reserve price, select at least one winning bid from among the one or more bids meeting the secret reserve price; and (iv) maintain the secret reserve price and the at least one winning bid (e.g., the price of the winning bid) in confidence following expiration of the auction. In one example, the at least one item may include a plurality of the same items (e.g., a plurality of substantially identical widgets).

In one example, the executable instructions, when executed, cause the at least one processing device to maintain the secret reserve price and the at least one winning bid in confidence following expiration of the auction by causing the at least one processing device to securely store data indicative of the secret reserve price and the at least one winning bid such that the data is not publicly available.

In another example, the executable instructions, when executed, further cause the at least one processing device to maintain the one or more bids, the at least one winning bid, and the secret reserve price in confidence during the auction (i.e., after the auction has commenced but before the auction has expired/concluded). In one example, the one or more bids, the at least one winning bid, and the secret reserve price are maintained in confidence by securely storing, by the at least one processing device, data indicative of the one or more bids, the at least one winning bid, and the secret reserve price such that the data is not publicly available.

In yet another example, the executable instructions, when executed, cause the at least one processing device to select at least one winning bid from among the one or more bids meeting the secret reserve price by causing the at least one processing device to select the at least one winning bid having a highest bid price from among the one or more bids meeting the secret reserve price.

In one example, the executable instructions, when executed, cause the at least one processing device to determine which of the one or more bids meet a secret reserve price associated with the at least one item by causing the at least one processing device to compare each of the one or more bids to the secret reserve price to determine whether each of the one or more bids are greater than or equal to the secret reserve price.

In another example, the executable instructions, when executed, further cause the at least one processing device to associate a prize with the at least one winning bid, wherein the prize is different than the at least one item being auctioned. In one example, the prize is associated with the winning bid having the highest bid price from among a plurality of winning bids.

In still another example, the secret reserve price indicates a minimum bid price necessary for any individual bid of the one or more bids to be eligible to win the auction. In yet another example, the at least one item being auctioned includes either a good or a service.

Related methods and computer-readable media are also disclosed.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram generally depicting one example of a computing system in accordance with the present disclosure.

FIG. 2 is a block diagram generally depicting one example of an auction controller in accordance with the present disclosure

FIG. 3 is a block diagram generally depicting one example of an auction process in accordance with the present disclosure.

FIG. 4 is a flowchart generally depicting one example of a method for processing a bid in accordance with the present disclosure.

FIG. 5 is a flowchart generally depicting one example of a method for determining the winners of an auction and notifying the auction participants.

FIG. 6 is a graph generally depicting one example of a bid distribution for an auction whereby the bids over the secret reserve price are illustrated as being “winning” bids.

FIG. 7 illustrates one example of a data structure in accordance with the present disclosure.

FIG. 8 illustrates one example of a graphical user interface that may be used to participate in an auction in accordance with the present disclosure.

FIG. 9 illustrates another example of a graphical user interface that may be used to participate in an auction in accordance with the present disclosure.

FIG. 10 illustrates one example of a bidding tool that may be used to place a bid in accordance with the present disclosure.

FIG. 11 is a flowchart generally depicting one example of a method for facilitating an auction of at least one item in accordance with the present disclosure.

FIG. 12 is a flowchart generally depicting another example of a method for facilitating an auction of at least one item in accordance with the present disclosure.

### DETAILED DESCRIPTION

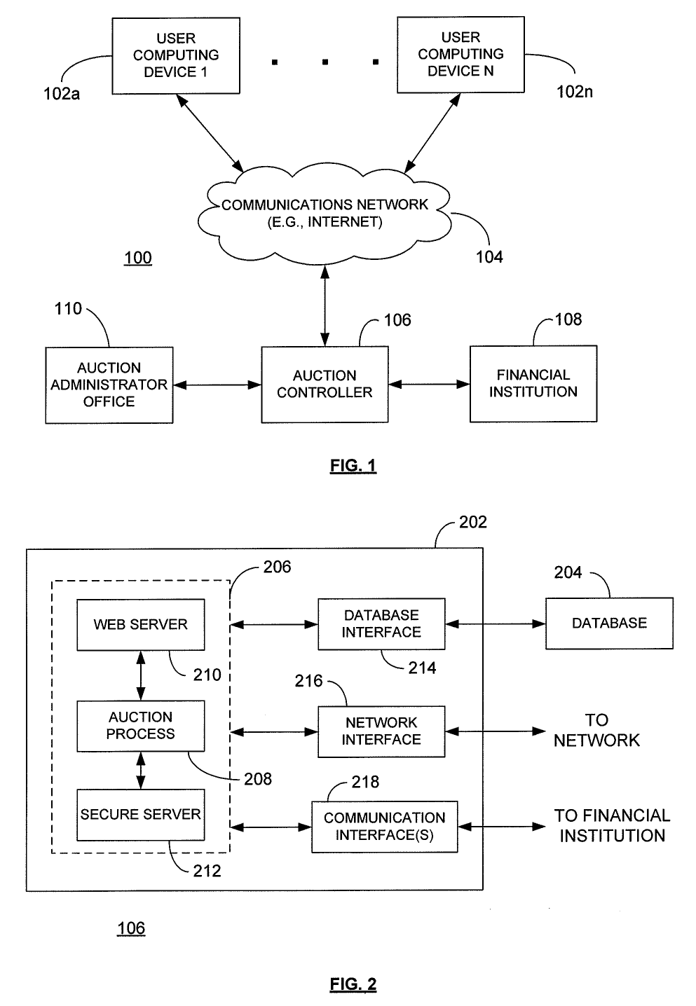

The following description of the embodiments is merely exemplary in nature and is in no way intended to limit the disclosure, its application, or uses. FIG. 1 illustrates a computing system 100 comprising a plurality of computers 102 in communication with each other through a communications network 104. An auction controller 106, coupled to the communications network 104, is capable of communicating with the computers 102. In one example, the communications network 104 comprises a publicly available computer network, such as the Internet or World Wide Web. However, it is understood that the present disclosure is not limited in this regard; the network 104 may comprise or include a private computer network equally well. Each of the computers 102 (e.g., computers 102a through 102n, for as many n computers as desired) may be, for example, a personal computer, such as a desktop or laptop computer. In other examples, each computer 102 may comprise a personal digital assistant (PDAs), cellular telephone, Smartphone, tablet (e.g., an Apple® iPad®), camera, or any other suitable electronic device capable of performing the computing functions described herein. At a minimum, each computer 102 should support a common communication protocol with the auction controller 106, such as the TCP/IP suite of protocols used to support Internet and Ethernet communications. Of course, other communications protocols known in the art could be equally used dependent, in part, upon the type of communications network 104 employed.

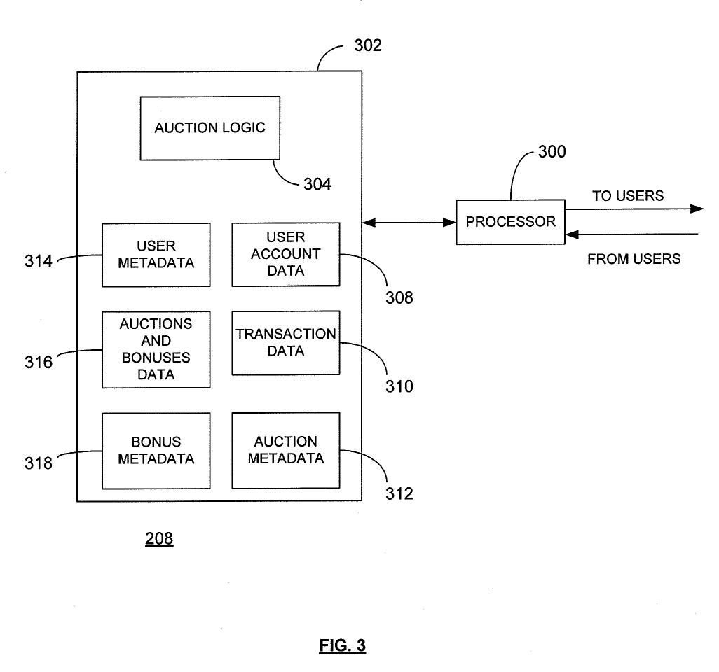

The auction controller 106 serves to implement an on-line auction in accordance with the present disclosure and will be described in further detail with reference to FIGS. 2 and 3. Generally, the auction controller 106 functions to automate interface operations with bidders/potential bidders of a given auction, to implement auction functionality (e.g., display auction information, merchandise information, retail pricing for the merchandise, provide a graphical user interface (GUI) allowing users to bid on merchandise up for auction, etc.), and to support settlement/payment activities. To this end, the auction controller 106 is in communication with one or more financial institutions 108 capable of verifying customer credit availability and limits, issuing payments, holding funds while awaiting transaction clearance and the like.

The auction controller is also in communication with an auction administration office 110. The auction administration office 110 includes personnel necessary to maintain operation of the auction controller 106, field customer inquiries, ensure auction settlement and generally administer operations of the on-line auction.

Referring now to FIG. 2, a more detailed view of one example of the auction controller 106 is provided. In this example, the auction controller 106 comprises two servers 202, 204, such as SUN ENTERPRISE servers, operating in concert to provide an on-line auction system. It is understood that the present disclosure need not be limited to an on-line implementation and, and is susceptible to other implementations. For example, communications between individuals and the auction controller 106 could be carried out using telephone, facsimile, postal mail, or other off-line methods of communication. It is further understood that other implementations (including various hardware implementations) encompassing the same functionality described herein will be readily apparent to those having ordinary skill in the art.

In the implementation shown, a first server 202 communicates via a database interface 214 with a second server configured to operate as a database 204. Techniques for configuring servers in this manner are well-known in the art. The database 204 stores all relevant information necessary to complete auction transactions, such as bidder and seller identifications, account identifications, passwords, information regarding specific bids and/or offers, credit information, the seller's secret reserve price, the number of items available at auction, etc. The first server 202 implements the auction functionality 206. As shown, the auction functionality 206 encompasses an auction process 208, a web server 210, and a secure server 212. Although not shown, the first server 202 comprises one or more processing units (such as microprocessors, microcontrollers, etc.) executing stored, computer-readable instructions to provide the auction functionality 206. Likewise, the various interfaces 214-218 shown incorporate hardware and/or software implementations, as known in the art.

The auction process 208 implements functionality necessary to provide an automated on-line auction system including, but not limited to, providing data to the web server 210 for presentation to a user of the on-line auction system. The auction process 208 will be described in additional detail with respect to FIG. 3. The web server 210 handles all non-secure interactions between the auction controller 106 and the computers 102 residing on the computer network 104. In one example, data received from the auction process 208 by the web server 210 comprises HTML-compliant data suitable for presentation via a web-page. In contrast, the secure server 212 handles all secure interactions (such as would be used when providing financial account data or other confidential information to the auction controller 106) between the controller 106 and computers 102.

The network interface 216 couples the controller 106 to the computer network 104. This includes support and termination of network protocols necessary to communicate via the computer network 104. In particular, the network interface 216 operates to recognize transmissions intended for the auction controller 106 and, in a similar manner, to ensure that communications being sent to various computers 102 are properly routed. Although shown as a separate component from the web server 210 and secure server 212, it is understood that the functionality provided by the network interface 216 could be incorporated into one or both of the servers 210, 212. As shown, the communication interface(s) 218 allow the controller 106 to communicate with the financial institution 108, for example through the use of a dial-up line, a direct connection or the like, a secure Internet connection, or any other suitable communication channel, either wired or wireless, as known in the art.

Referring now to FIG. 3, a more detailed view of the auction process 208 of FIG. 2 is shown. The auction process 208 is preferably implemented using computer-readable instructions and data structures stored on a computer-readable medium 302 and executed by a processor 300 (e.g., a microprocessor, microcontroller, etc.). Additionally, the computer readable medium 302 may also store data that is manipulated by the processor 300 in conjunction with the execution of the computer-readable instructions. The processor 300 is preferably resident on the first server 202, whereas the computer-readable medium 302 may reside in the first server 202, the database 204 or a combination of the two. Although the computer-readable medium 302 preferably comprises random-access memory (RAM) and/or read-only memory (ROM) resident in the auction controller 106, the computer-readable medium 302 may also comprise other non-resident storage media, such as magnetic cassettes, floppy disks, flash memory cards, digital video disks, Bernoulli cartridges, RAMs, ROMs, and the like.

As shown, the computer-readable medium 302 comprises auction logic 304, user metadata 314, user account data 308, auctions and bonuses data 316, transaction data 310, bonus metadata 318, and auction metadata 312. The auction logic 304 implements those functions, preferably through the use of computer-readable instructions, susceptible to automation and necessary to conduct auction operations. Such functions include, but are not limited to, processing user accounts, providing displays of auctions and items being auctioned, receiving bids from users, determining whether a given bid is above the seller's secret reserve price (i.e., the minimum price that a user must bid in order to be in contention to win a particular auction), determining whether a given user is entitled to any bonus prize/reward due to the price of their bid (e.g., in one example, bonus prizes/rewards are provided to the auction winners with the highest n bids, where there are n prizes/rewards available for a particular auction), processing the bids, and/or other auction-oriented processing. Those having ordinary skill in the art will recognize other functionality useful in implementing an on-line auction system may be similarly included in the auction logic 304. The processor 300 executes the auction logic 304.

As shown in FIG. 3, user metadata 314, preferably resident in the database 204, is available to the auction process 208. The user metadata 314 comprises all pertinent information regarding users (i.e., auction participants/bidders) of the on-line auction. For example, user metadata 314 may include data about each user of the on-line auction, such as first and last name, billing address information, shipping address information, user level information (e.g., in one embodiment, users/bidders may be classified into different levels based upon their, for example, frequency of use with the on-line auction system). The user account data 308 comprises all pertinent information regarding users' accounts. For example, user account data 308 may include data about each user's account with the on-line auction facilitator, such as a user ID, a user login name, a user login-in password, a user formal name (i.e., a “nickname” for a user), a user email address, a URL associated with a user, user registration information, user status information, a user display name, etc.

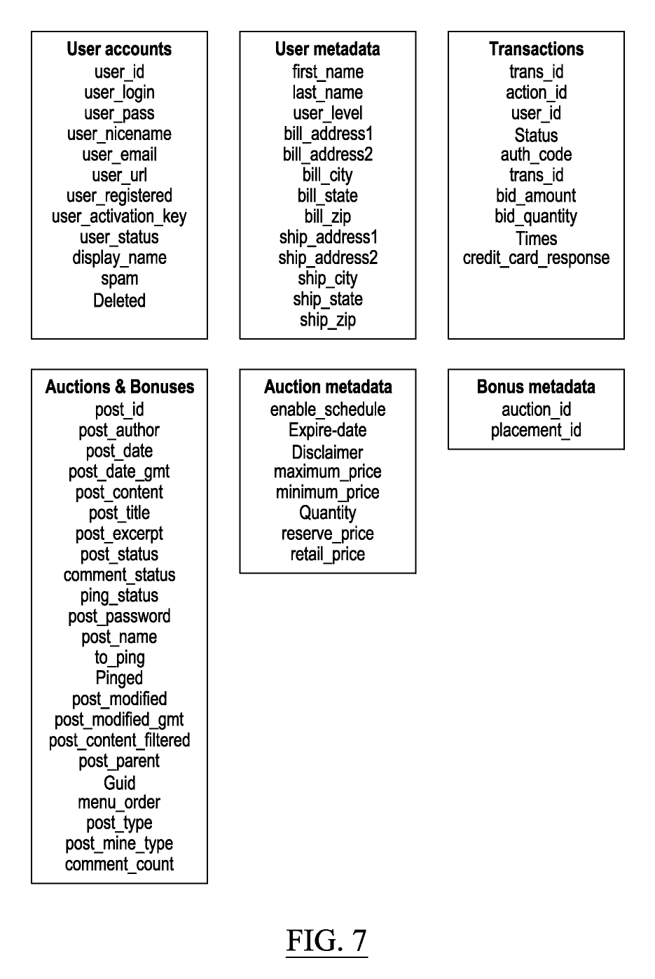

Auctions and bonuses data 316 comprises all pertinent information regarding the details/specifics of the different multi-unit auctions, which may be implemented (simultaneously, in one example) via the present disclosure. For example, auctions and bonuses data 316 may include information describing the good and/or service being offered in a particular auction and other information, such as the information set forth in the “Auctions and Bonuses” box illustrated in FIG. 7. Transaction data 310 comprises all pertinent information concerning the different transactions that may be facilitated via the present disclosure. For example, transaction data 310 may include transaction ID information (e.g., data identifying a specific transaction between a bidder and the auction functionality 206), auction ID information (e.g., data uniquely identifying each auction of a plurality of auctions), user ID information (e.g., data uniquely identifying each user that has entered into a transaction using the auction functionality 206), status information identifying, for example, whether a given auction is open or closed, etc. (see the box labeled “Transactions” in FIG. 7 for additional transaction data 310 capable of storage in the computer-readable medium 302).

Bonus metadata 318 comprises all pertinent information regarding the bonus prizes/rewards that may be offered in connection with a given auction. For example, bonus metadata 318 may include auction ID data identifying the particular auction to which a selected prize/reward is offered in connection with. Bonus metadata 318 may also include, for example, data describing the specific prizes/rewards offered in connection with different auctions. Finally, auction metadata 312 comprises all pertinent information regarding each of the auctions. For example, auction metadata 312 may include schedule information indicating when a particular auction will become available (i.e., open), when a particular auction expires (i.e., closes), disclaimer information setting forth any disclaimers governing the auction, maximum price data indicating the maximum price that a user can bid on a given item up for auction, minimum price data indicating the minimum price that a user can bid on a given item up for auction, quantity data indicating the total number of units of a given item (e.g., a good or service) available for a given auction, secret reserve price information indicating the secret reserve price that a seller/supplier has set for a given auction (i.e., the minimum price that a bidder needs to bid in order to be in contention to win an auction—bids below the secret reserve price cannot win the auction), and the retail price for an item up for auction (e.g., the average retail price for the item at issue). Preferred data structures for use in storing the data 308-318 discussed herein are illustrated in FIG. 7.

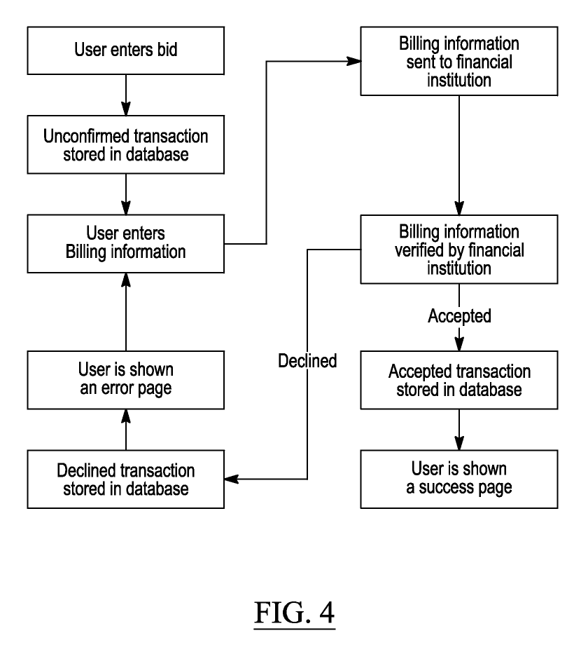

FIG. 4 illustrates a flow chart describing one method for processing bids using the auction functionality 206 described herein.

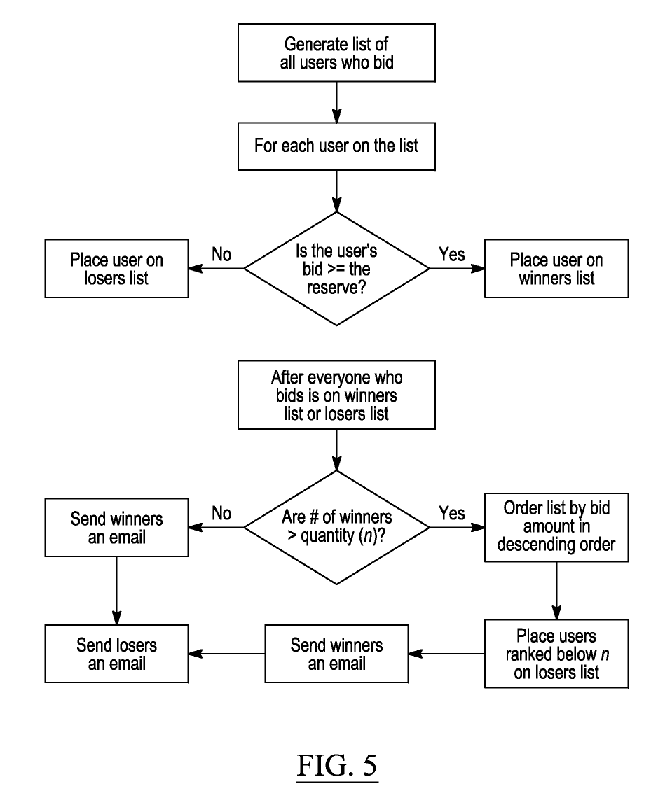

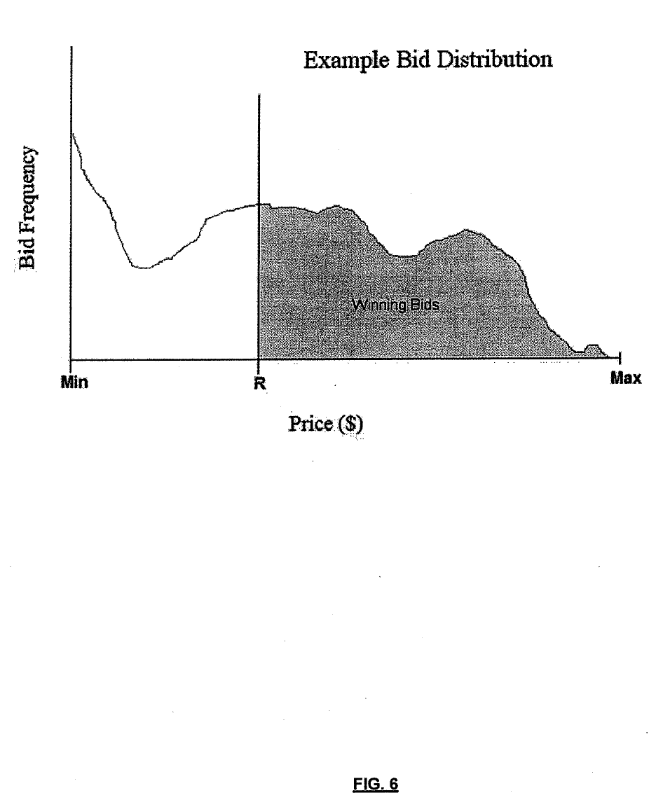

FIG. 5 illustrates additional flowcharts describing methods for determining which bidders win a particular auction in accordance with one example of the auction process 208. Notably, the upper flowchart of FIG. 5 illustrates the concept of the secret reserve price discussed throughout this disclosure. As evidenced by the decision box (“Is the user's bid [greater than or equal to] the secret reserve price?”), a determination is made after user(s) (i.e., auction participants/bidders) place bids as to whether any individual bid meets the secret reserve price.

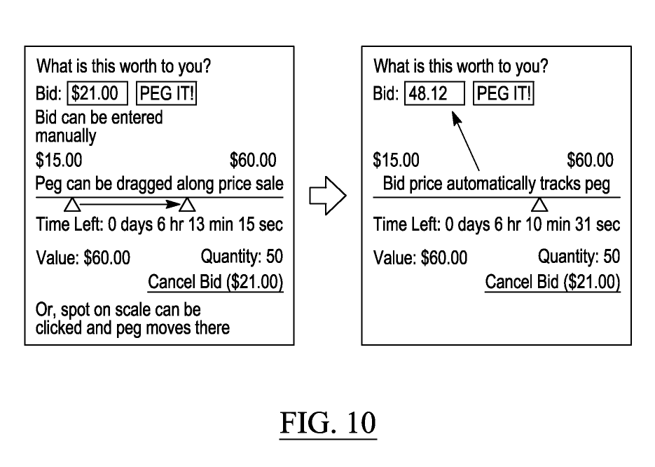

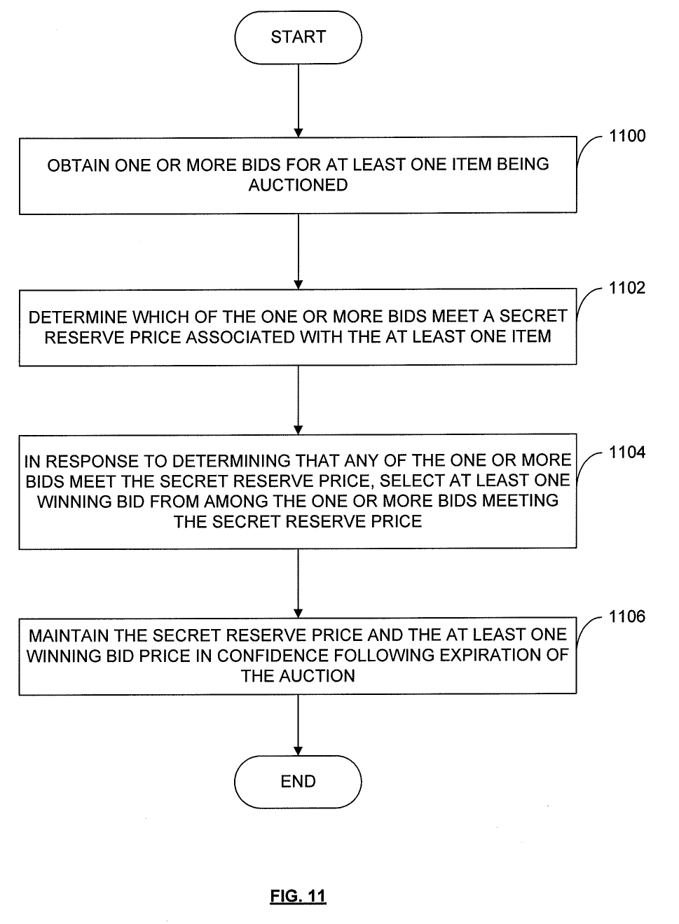

The secret reserve price is a price that the seller/supplier of the good and/or service placed at auction establishes prior to the opening of the auction (while this is generally true, in limited circumstances, it is recognized that a seller/supplier might lower their secret reserve price after the auction has opened, or in some instances, after the auction has closed). The secret reserve price is intended to represent the minimum bid-price at which the seller/supplier will actually sell the good/service via the auction. Thus, if a particular bid falls below the secret reserve price, that bid is not eligible to win the auction. However, the secret reserve price, as the name implies, is never published and is only known to the seller/supplier (i.e., the auctioneer) and the administrators of the auction, (e.g., the employees at the auction administrator office 110 who may input the secrete reserve price into the auction controller 106 to automate the determination of whether a particular bid met or exceeded the secret reserve price). Thus, bidders cannot know whether their bid was actually high enough to meet the secret reserve, and place them in contention to win the auction. From a bidders perspective, it would be ideal to place a bid that is a nominal amount above the secret reserve price. In such a scenario, the bidder may win the auction without paying as much for the item being auctioned as other bidders whose bids were substantially above the secret reserve price. While different bidders may pay different prices for the same item, the model of the present system is nonetheless attractive because the users/bidders themselves set the amount that they are willing to pay for a given item up for auction (e.g., by interacting with the bidding tool illustrated in FIG. 10). Because different users/bidders may end up paying different amounts for the same item being offered up for auction, the system of the present disclosure is referred to as a “price discriminatory” auction.

This model is particularly attractive to seller/suppliers because it allows them to sell certain units at prices substantially above the secret reserve price (i.e., substantially above the minimum price that they would have been willing to accept for a unit of an item up for auction). Accordingly, they are not forced to enter into a “daily deal” type of scenario where they must unload all of their items at one, drastically reduced price. Furthermore, because the secret reserve price is never published, there is not a publicly available market for the value of the item up for auction (aside from the retail prices). As a result, the auction model utilized by the auction process 208 of the present invention provides added protection against price erosion and brand deterioration. For example, when a consumer sees a particular item being offered at 50% off through a daily deal site, they are less likely to go and pay full retail price for that item. However, because the winning bid prices and the secret reserve price are never published in-line with the present disclosure, the market price of the items being offered up for auction do not experience the same extent of price erosion or brand deterioration.

The lower flow chart of FIG. 5 provides one example of a method for breaking a tie between a plurality of bids above the secret reserve price, where the plurality of bids above the secret reserve price is greater than the number of units of the good/service being auctioned. For example, in a given auction, ten (10) widgets might be placed up for auction. Continuing with this example, the secret reserve price may be $50.00 for each widget (again, this figure is not published and is unknown to the bidders). At the expiration of the auction, there might be 20 bids above the $50 secret reserve price. In such a circumstance, there are more bids above the secret reserve price than there are units of the good/service being auctioned. Accordingly, the present disclosure envisions a number of techniques for determining which bidders “win” the auction (i.e., which bidders' bids will be accepted, their credit cards charged, and the items shipped for delivery to their preferred addresses). In one example, the highest n bids win the auction, where there are n units of the good/service available. Of course, other suitable tie-breaking methods could be equally employed (e.g., the lowest ten bids, the first ten bids in time, or any suitable combination of these rules for breaking ties).

FIG. 6 is a graphical representation of the distribution of bids for a given auction. The y-axis indicates the frequency at which different priced bids are made. The x-axis indicates the price of the bids. Point R along the x-axis represents the secret reserve price. Thus, the bids to the right of R (i.e., the bids greater than secret reserve price $(R)) are depicted as being winning bids. Of course, as discussed above, in some examples of the present disclosure it is necessary to apply tie-breaking rules in order to determine which bids are winning bids.

FIG. 7 illustrates a preferred data structure for the user metadata 314, user account data 308, auctions and bonuses data 316, transaction data 310, bonus metadata 318, and auction metadata 312. The data structure, residing on a computer-readable medium, comprises various records useful in maintaining and processing bids/winners/bonuses/auctions/etc. related to a multi-unit price discriminatory auction with a secret reserve.

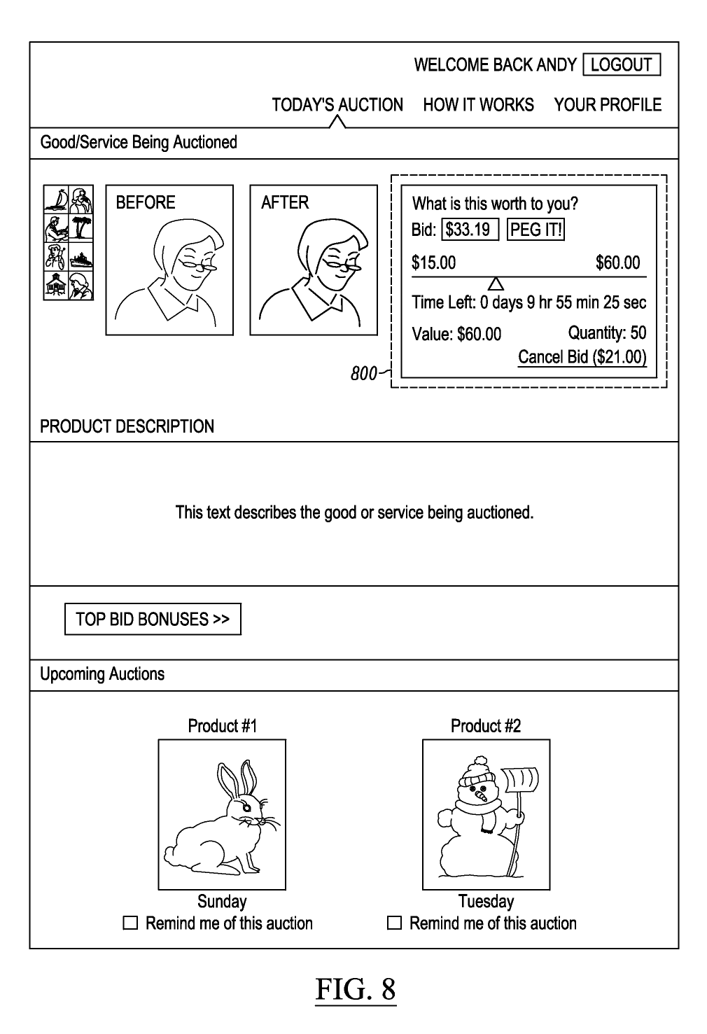

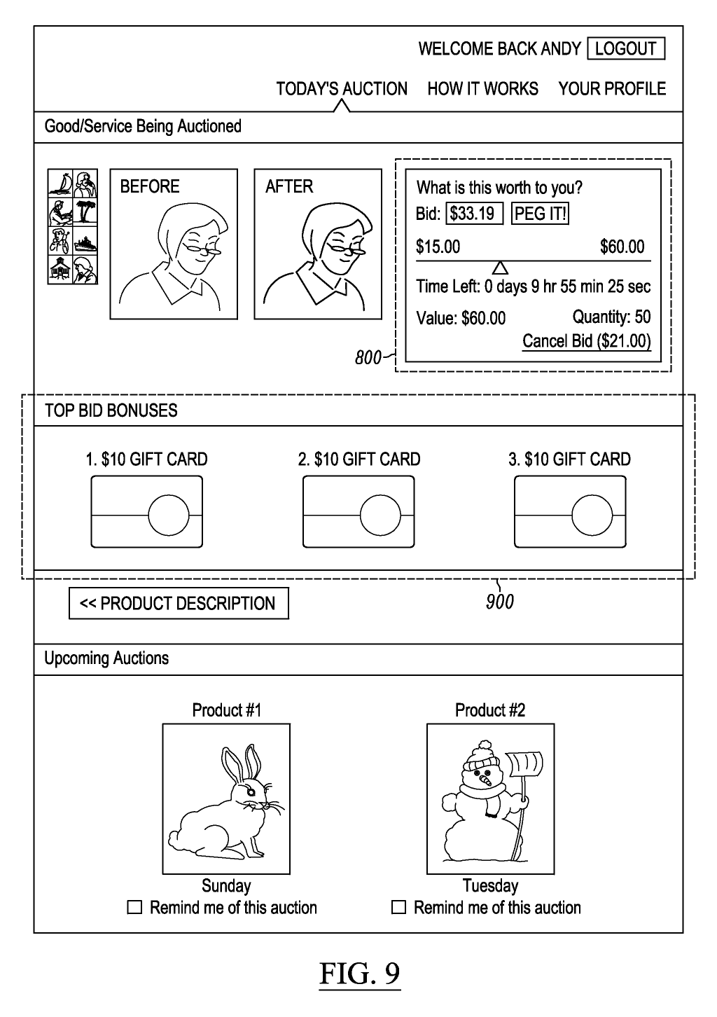

Referring now to FIG. 8, an auction display for particular use in placing bids on a given auction is illustrated. The displays illustrated in FIGS. 8-9 are exemplary displays that would be provided on the computers of users of a multi-unit price discriminatory auction with a secret reserve implemented by the auction process 208. It should be noted that techniques for obtaining the data included in the displays shown in FIGS. 8-9 are well known in the art. The display shown in FIG. 8 is provided to a user that has chosen a particular auction to participate in (an auction for “Willow Post Image Restoration” in this case). For example, the auction process 208 may provide data to the web server 210 for presentation of the on-line auction system illustrated in FIGS. 8-9. As shown in FIG. 8, the specific item (i.e., service) up for auction is an image restoration deal. The bidding tool 800 may be used to place a bid on the item up for auction and also conveys additional details about the auction. For example, the bidding tool 800 indicates (i) the retail value of the item up for auction ($60.00 in this case); (ii) the quantity of items available (fifty in this case); (iii) the time remaining on the auction (i.e., how much longer the auction is open); (iv) a sliding scale that a user can interact with to set their desired bid, where the sliding scale includes a minimum price ($15.00) that is different from the secret reserve price (which is not shown) and a maximum price ($60.00) that is typically the suggested retail price; (v) a bid indicator box indicating the bid price that was selected using the sliding scale; and (vi) an execution button (“PEG IT!”) that a user can select to place their bid.

Referring now to FIG. 9, another auction display for use in placing bids on a given auction is illustrated. FIG. 9 differs from FIG. 8 in that FIG. 9 includes top bid bonus information 900. The top bid bonus information 900 indicates the prize(s)/reward(s) that may be given to the bidders with, for example, the top three bids in a given auction.

FIG. 10 illustrates the functionality of the bidding tool 800. As shown, the sliding scale on the bidding tool 800 includes a “peg.” A user can interact with the bidding tool over their computer 102 using techniques known in the art (e.g., by clicking on the peg with their mouse icon). A user can drag the peg to the location on the scale that corresponds to the price that they are willing to bid for the item at auction. The bid box (next to the “PEG IT!” button) indicates the price that has been selected using the sliding scale. Alternatively, a user can enter the precise price that they are willing to pay into the bid box, and the peg on the sliding scale will move to the appropriate location on the scale to reflect the manually entered bid price.

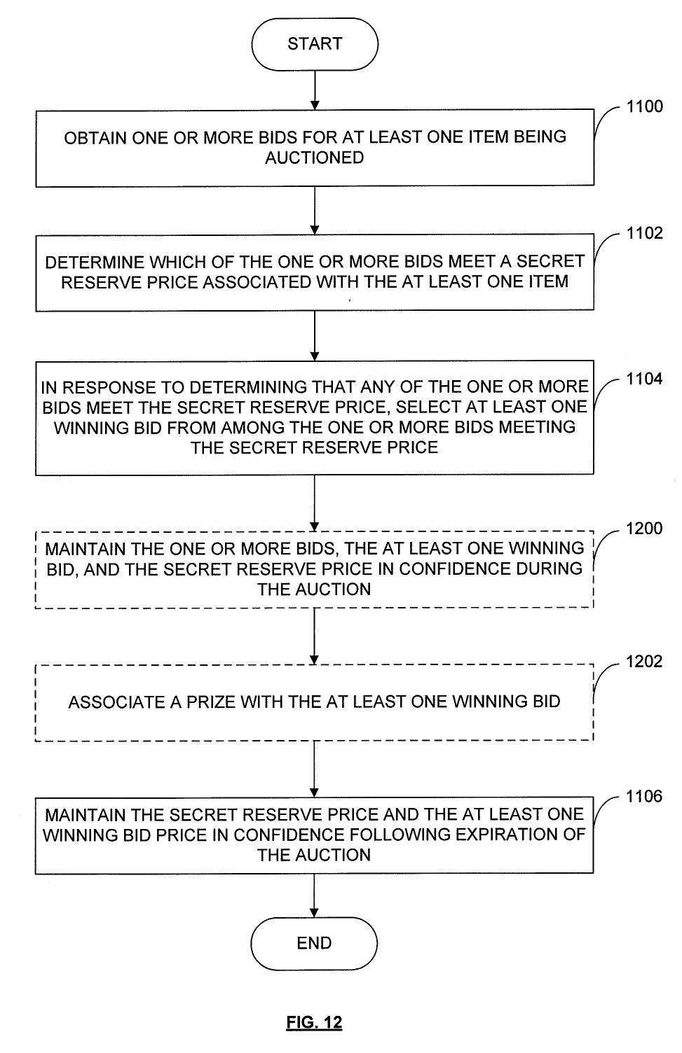

FIG. 11 is a flowchart generally depicting one example of a method for facilitating an auction of at least one item in accordance with the present disclosure. While the auction logic 106 is a form for implementing the processing described herein (including that illustrated in FIGS. 11 and 12), those having ordinary skill in the art will appreciate that other, functionally equivalent techniques may be employed. For example, as known in the art, some or all of the functionalities implemented via executable instructions may also be implemented using firmware and/or hardware devices such as application specific integrated circuits (ASICs), programmable logic arrays, state machines, etc. Further still, other implementations of the auction logic 106 may include a greater or lesser number of components than those illustrated. Once again, those of ordinary skill in the art will appreciate the wide number of variations that may be used is this manner.

Beginning at block 1100, one or more bids are obtained for at least one item being auctioned. While the method described herein refers to “at least one item,” it is recognized that, in many instances, more than one item (e.g., multiple units of the same item) may be available through a single auction (i.e., “a multi-unit homogeneous auction”). Furthermore, as used herein, the term “item” may refer to either a good or a service. For instance, the “item” being auctioned could be the right to receive a massage at a massage parlor, which is technically a service.

At block 1102, a determination is made regarding which of the one or more bids meet a secret reserve price associated with the at least one item. As discussed above, and in accordance with the present disclosure, a seller of item(s) being auctioned will set a secret reserve price defining the minimum price necessary for any individual bid to be eligible to win the auction. In one example, the determination made at block 1102 is accomplished by comparing each of the bids that are obtained to the secret reserve price in order to determine if each (or any, for that matter) of the bids are greater than or equal to the secret reserve price.

At block 1104, at least one winning bid is selected from among the one or more bids meeting the secret reserve price. This selection is accomplished in response to a determination that any of the one or more bids meet the secret reserve price. For example, it might be the case that five bids meet the secret reserve price, however, there are only three units of the item up for auction available. In this scenario, the winning bids that are selected could be, for example, the three highest bids (out of the five total bids that met the secret reserve price). It is worth noting that the present disclosure is not intended to be limited in this regard though, and the selection of the winning bids from among the total bids meeting the secret reserve price can be accomplished in any suitable fashion (e.g., by selecting, as the winning bids, the three bids having the lowest bid prices above the secret reserve price).

At block 1106, the secret reserve price and the at least one winning bid (e.g., the price of the at least one winning bid) are maintained in confidence following the expiration of the auction. In one example, maintaining the secret reserve price and the at least one winning bid includes securely storing data indicative of the secret reserve price and the at least one winning bid such that the data is not publicly available. For example, in an embodiment where the auction logic 106 implements the processing described at blocks 1100-1106, the data may be stored in database 204. The data may be secured using data security techniques known in the art such as, but not limited to, data encryption (e.g., via hardware or software), the use of security tokens (e.g., those using public-key cryptography standards), data masking, etc. Regardless of the security measure(s) used, the data is not publicly disclosed. By maintaining the secret reserve price and the at least one winning bid in confidence, undesirable consequences (e.g., price erosion of the item being auctioned) can be limited or avoided all together.

FIG. 12 is a flowchart generally depicting another example of a method for facilitating an auction of at least one item in accordance with the present disclosure. Blocks 1100-1106 are carried out in accordance with the above-discussion concerning FIG. 11. At block 1200, the one or more bids, the at least one winning bid, and the secret reserve price are maintained in confidence during the auction (i.e., after the auction has commenced but before the auction has expired/concluded). Similar techniques to those described above may be used to maintain the one or more bids, the at least one winning bid, and the secret reserve price in confidence during the auction. That is, data indicative of the one or more bids, the at least one winning bid, and the secret reserve price is securely stored in a storage medium, such as database 204. Again, suitable security techniques known in the art may be employed to prevent the public disclosure of this information.

At block 1202, a prize is associated with the at least one winning bid. In one example, the prize is different than the item being auctioned. For example and as discussed with regard to FIG. 9 herein, in one embodiment of the present disclosure, a prize may be given to the bidder(s) with the winning bids. For example, in one embodiment, a prize is associated with the winning bid having the highest bid price. In this manner, the prize may act to console the user who placed the winning bid having the highest bid price, as that user may be upset by the fact that they bid too high above the secret reserve price. Of course, prizes may be associated with as many winning bids as desired.

Among other advantages, the present disclosure provides a method and apparatus for providing a homogeneous discriminatory price auction with secret reserve. The auction model of the present disclosure mitigates the effects of price sniping by keeping all of the bids and the secret reserve price secret (i.e., unknown to the general public). Further, the auction model of the present disclosure allows a seller/supplier to offer multiple items of the same good/service via a single auction, eliminating the need to set up “clone” auctions. In addition, the use of a secret reserve price and the confidential nature of the bids mitigates the effects of price erosion and brand deterioration associated with conventional daily deal and on-line auction sites. Finally, the auction model of the present disclosure permits the sellers/suppliers to capture bids that are well above the drastically reduced price traditionally associated with daily deal sites (and well above their secret reserve price in many instances).

The above detailed description and the examples described therein have been presented for the purposes of illustration and description only and not by way of limitation. It is therefore contemplated that the present disclosure cover any and all modifications, variations or equivalents that fall within the spirit and scope of the basic underlying principles disclosed above and claimed herein.

What is claimed is:

1. In at least one processing device, a method for facilitating an auction of at least one item, the method comprising:
obtaining, by the at least one processing device, one or more bids for the at least one item being auctioned;
determining, by the at least one processing device, which of the one or more bids meet a secret reserve price associated with the at least one item;
in response to determining that any of the one or more bids meet the secret reserve price, selecting, by the at least one processing device, at least one winning bid from among the one or more bids meeting the secret reserve price; and
maintaining the secret reserve price and the at least one winning bid in confidence following expiration of the auction.

2. The method of claim 1, wherein maintaining the secret reserve price and the at least one winning bid in confidence following expiration of the auction comprises securely storing data indicative of the secret reserve price and the at least one winning bid such that the data is not publicly available.

3. The method of claim 1, further comprising:
maintaining the one or more bids, the at least one winning bid, and the secret reserve price in confidence during the auction.

4. The method of claim 3, wherein maintaining the one or more bids, the at least one winning bid, and the secret reserve price in confidence during the auction comprises securely storing data indicative of the one or more bids, the at least one winning bid, and the secret reserve price such that the data is not publicly available.

5. The method of claim 1, wherein selecting at least one winning bid from among the one or more bids meeting the secret reserve price comprises selecting the at least one winning bid having a highest bid price from among the one or more bids meeting the secret reserve price.

6. The method of claim 1, wherein determining which of the one or more bids meet the secret reserve price comprises comparing each of the one or more bids to the secret reserve price to determine whether each of the one or more bids are greater than or equal to the secret reserve price.

7. The method of claim 1, wherein the secret reserve price indicates a minimum bid price necessary for any individual bid of the one or more bids to be eligible to win the auction.

8. The method of claim 1, further comprising:
associating a prize with the at least one winning bid, wherein the prize is different than the at least one item being auctioned.

9. The method of claim 8, wherein associating the prize with the at least one winning bid comprises associating the prize with the at least one winning bid having a highest bid price.

10. The method of claim 1, wherein the at least one item comprises at least one of a good and a service.

11. An apparatus for facilitating an auction of at least one item, the apparatus comprising:
at least one processing device; and
memory operatively connected to the at least one processing device, the memory comprising executable instructions that when executed by the at least one processing device cause the at least one processing device to:
obtain one or more bids for the at least one item being auctioned;
determine which of the one or more bids meet a secret reserve price associated with the at least one item;
in response to determining that any of the one or more bids meet the secret reserve price, select at least one winning bid from among the one or more bids meeting the secret reserve price; and
maintain the secret reserve price and the at least one winning bid in confidence following expiration of the auction.

12. The apparatus of claim 11, wherein the executable instructions, when executed by the at least one processing device, cause the at least one processing device to maintain the secret reserve price and the at least one winning bid in confidence following expiration of the auction by causing the at least one processing device to securely store data indicative of the secret reserve price and the at least one winning bid such that the data is not publicly available.

13. The apparatus of claim 11, wherein the executable instructions, when executed by the at least one processing device, further cause the at least one processing device to:
maintain the one or more bids, the at least one winning bid, and the secret reserve price in confidence during the auction.

14. The apparatus of claim 13, wherein the executable instructions, when executed by the at least one processing device, cause the at least one processing device to maintain the one or more bids, the at least one winning bid, and the secret reserve price in confidence during the auction by causing the at least one processing device to securely store data indicative of the one or more bids, the at least one winning bid, and the secret reserve price such that the data is not publicly available.

15. The apparatus of claim 11, wherein the executable instructions, when executed by the at least one processing device, cause the at least one processing device to select at least one winning bid from among the one or more bids meeting the secret reserve price by causing the at least one processing device to select the at least one winning bid having a highest bid price from among the one or more bids meeting the secret reserve price.

16. The apparatus of claim 11, wherein the executable instructions, when executed by the at least one processing device, cause the at least one processing device to determine which of the one or more bids meet a secret reserve price associated with the at least one item by causing the at least one processing device to compare each of the one or more bids to the secret reserve price to determine whether each of the one or more bids are greater than or equal to the secret reserve price.

17. The apparatus of claim 11, wherein the secret reserve price indicates a minimum bid price necessary for any individual bid of the one or more bids to be eligible to win the auction.

18. The apparatus of claim 11, wherein the executable instructions, when executed by the at least one processing device, further cause the at least one processing device to:
associate a prize with the at least one winning bid, wherein the prize is different than the at least one item being auctioned.

19. The apparatus of claim 18, wherein the executable instructions, when executed by the at least one processing device, cause the at least one processing device to associate the prize with the at least one winning bid by causing the at least one processing device to associate the prize with the at least one winning bid having a highest bid price.

20. A computer-readable medium comprising executable instructions that when executed by at least one processing device cause the at least one processing device to:
obtain one or more bids for at least one item being auctioned;
determine which of the one or more bids meet a secret reserve price associated with the at least one item;
in response to determining that any of the one or more bids meet the secret reserve price, select at least one winning bid from among the one or more bids meeting the secret reserve price; and
maintain the secret reserve price and the at least one winning bid in confidence following expiration of the auction.
